(19) United States
(12) Patent Application Publication
(10) Pub. No.: US 2015/0007900 A1
(43) Pub. Date: Jan. 8, 2015

(54) VENTURI MIXER

(71) Applicant: Johnson Electric S.A., Murten (CH)

(72) Inventors: Hong Guang LI, Shenzhen (CN); Serge Pesetsky, Shenzhen (CN); Chuan Hui FANG, Hong Kong (CN)

(21) Appl. No.: 14/322,512

(22) Filed: Jul. 2, 2014

(30) Foreign Application Priority Data
Jul. 2, 2013 (CN) 201310275074.1

(51) Int. Cl. F23D 14/04; F23D 14/62; B01F 5/04

(52) U.S. Cl. CPC F23D 14/04; B01F 5/0413; F23D 14/62; B01F 2005/0435
USPC 137/892

(57) ABSTRACT

A venturi mixer has first and second fluid input sections, an output section and a throat. The first fluid input section has first and second ends, and a decreasing cross sectional area from the first end to the second end. The throat is disposed at the second end of the first fluid input section and has a plurality of orifices. The output section has a first end connected with the throat and a second end, and an increasing cross sectional area from the first end to the second end. The second fluid input section has an inlet and a housing connected to the inlet and enclosing the orifices of the throat.

### CROSS REFERENCE TO RELATED APPLICATIONS

This non-provisional patent application claims priority under 35 U.S.C. §119(a) from Patent Application No. 201310275074.1 filed in The People's Republic of China on Jul. 2, 2013, the entire contents of which are hereby incorporated by reference.

### FIELD OF THE INVENTION

This invention relates generally to a fluid mixing device and in particular to a venturi mixer with mixing ratio control.

### BACKGROUND OF THE INVENTION

Venturi mixers based on the Venturi effect are widely used as fluid injectors. A conventional venturi mixer 10 is shown in FIG. 1. One fluid 1, such as air, flows into mixer 10 through an air input section 11, passes through a throat 12, and flows out though a mixer output section 13. Another fluid 2, such as natural gas, flows into a gas input section 14, and mixes with the air in throat 12. A replaceable gas control valve 15 with a predetermined interior diameter is mounted on the gas input section 14 and controls the air/gas ratio. When a different air/gas volume ratio is desired, gas control valve 15 with a different interior diameter will be mounted on the gas input section 14. In mixer 10, the change of air/gas volume ratio is not continuous and needs multiple replaceable gas control valves 15. In addition, replacing gas control valve 15 would disrupt the operation of mixer 10.

U.S. Pat. No. 5,971,026 discloses an air-gas mixing valve 20 shown in FIGS. 2 and 3. Air-gas mixing valve 20 includes an inner pipe 22 and an outer pipe 24 around inner pipe 22, thereby forming a chamber 23 between inner pipe 22 and outer pipe 24. Air 1 flows into air inlet 27 and a throat 25 is formed on inner pipe 22 with a circular gap communicated with chamber 23. Gas 2 flows through an adjusting component 26 into chamber 23, and then flows into inner pipe 22 through throat 25 to mix with air 1. The mixture 3 then flows out of outlet 29. A screw 28 is disposed on adjusting component 26 to adjust flow rate of gas 2. However, mixing valve 20 has limited air/gas ratio adjustment precision and range. First limitation is related to adjustment of the air/gas volume ratio for gas mixture with reduced atomic mass of carbon and increased atomic mass of hydrogen, i.e., quantity of atomic mass of carbon in gas sometimes fluctuates due to different gas source, which means air-gas ratio sometimes need slight adjustment. For such gas mixtures, air-gas ratio less than 9:1 can be required. Second limitation is related to reliability of the air/gas volume ratio control at high flow rate when a premix blower, installed at the output of a venturi mixer, supplies air-gas mixture on a maximum firing rate of the boiler. Third limitation is related to unsatisfactory air-gas mixing efficiency at high flow rate, because the gas does not penetrate deeply into the main stream of air and has tendency to travel near the wall of the venturi tube. Thus, the efficiency and the reliability of mixing decrease at high air flow rate.

### SUMMARY OF THE INVENTION

Hence there is a desire for a venturi mixer which has a simple yet accurate control mechanism to control the air/gas volume ratio, preferably over a wide range.

Accordingly, in one aspect thereof, the present invention provides a venturi mixer, comprising: a first fluid input section having a first end and a second end, and an decreasing cross sectional area from the first end to the second end; a throat disposed at the second end of the first fluid input section and having a first plurality of orifices; a second fluid input section having an inlet and a housing connected to the inlet and enclosing the plurality of orifices in the throat; and an output section having a first end connected with the throat and a second end, and an increasing cross sectional area from the first end to the second end.

Preferably, the second fluid input section further comprises a flow adjustment mechanism connected to the housing.

Preferably, the second fluid input section includes an inlet chamber and the flow adjustment mechanism includes a movable conical plug disposed in the inlet chamber.

Preferably, the flow adjustment mechanism comprises a hand screw threadedly engaged with a pipe extending from the inlet chamber and wherein the conical plug is located on an inner axial end of the hand screw.

Preferably, the conical plug is arranged to provide an adjustable restriction to the flow of fluid from the inlet chamber to the orifices in the throat.

Alternatively, the flow adjustment mechanism comprises a cover rotatably disposed about a radially outer surface of the throat; the cover having a second plurality of orifices that are alignable with the first plurality of orifices in the throat; and the cover being movable to selectively align or misalign the orifices in the cover with the orifices in the throat to vary the flow of fluid through the orifices in the throat.

Preferably, the cover is rotatably between a first position in which the orifices in the throat are fully open and a second position in which the orifices in the throat are fully closed.

Preferably, the flow adjustment mechanism includes: a ring gear fixed to the cover; and a driving gear, in mesh with the ring gear, for rotating the cover.

Preferably, the flow adjustment mechanism further comprises a hand screw having a shaft rotatably sealed to and extending through the housing, an axially inner end of the shaft is joined to the driving gear and the other end of the shaft forms a handle.

Preferably, the driving gear and the shaft are integrally formed as a monolithic structure.

Preferably, the gear ring and the rotatable cover are integrally formed as a monolithic structure.

Preferably, the output section and the housing are integrally formed as a monolithic structure.

Preferably, the first fluid input section, the second fluid input section, and the output section are made of a static dissipative plastics material.

The venturi mixers according to the embodiments of the present invention can provide a reliable air/gas volume ratio control at higher flow. This is an advantage when the premix blower supplies air-gas mixture at a maximum firing rate of the boiler. The venturi mixer can provide an accurate control for air/gas volume ratio in a wide range of air/gas ratios and a reliability of air/gas mixing when the blower is operating at high speed or maximal mainstream air flow rates. For the same blower speed, venturi mixers of the present invention can reach a higher air/gas volume flow rate. Additionally, venturi mixers according to the present invention can provide lean combustion process resulting in minimal CO & NO presence in combustion products. Some embodiments lend themselves to being formed by injection molding of, for example, static dissipative plastics material, providing a light weight solution without the buildup of static charges.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a prior art venturi mixer;

FIG. 2 is a sectional view of another prior art venturi mixer;

FIG. 3 is another sectional view of the mixer of FIG. 2;

FIG. 4 illustrates a venturi mixer in accordance with a first preferred embodiment of the present invention;

FIG. 5 is a sectional view of the mixer of FIG. 4;

FIG. 6 illustrates a venturi mixer in accordance with another preferred embodiment of the present invention;

FIG. 7 illustrates an adjustment mechanism, being a part of the venturi mixer of FIG. 6;

FIG. 8 illustrates the adjustment mechanism of FIG. 7, in a different position;

FIG. 9 illustrates an air inlet section of the venturi mixer of FIG. 6;

FIG. 10 illustrates a rotatable cover, being a part of the adjustment mechanism of FIG. 7;

FIG. 11 is a sectional view of the venturi mixer of FIG. 6;

FIG. 12 is a graph illustrating the relationship between Air/Gas volume ratio and flow controller position for the prior art venturi mixer of FIG. 2;

FIG. 13 is a graph illustrating the relationship between Air/Gas volume ratio and flow controller position for the venturi mixer of FIG. 4;

FIG. 14 is a graph illustrating the relationship between Air/Gas volume ratio and flow controller position for the venturi mixer of FIG. 6;

FIG. 15 is a graph illustrating the relationship between Air/Gas Volume Ratio, Flow Rate and Blower Speed for the prior art venturi mixer of FIG. 2;

FIG. 16 is a graph illustrating the relationship between Air/Gas Volume Ratio, Flow Rate and Blower Speed for the venturi mixer of FIG. 4; and

FIG. 17 is a graph illustrating the relationship between Air/Gas Volume Ratio, Flow Rate and Blower Speed for the venturi mixer of FIG. 6.

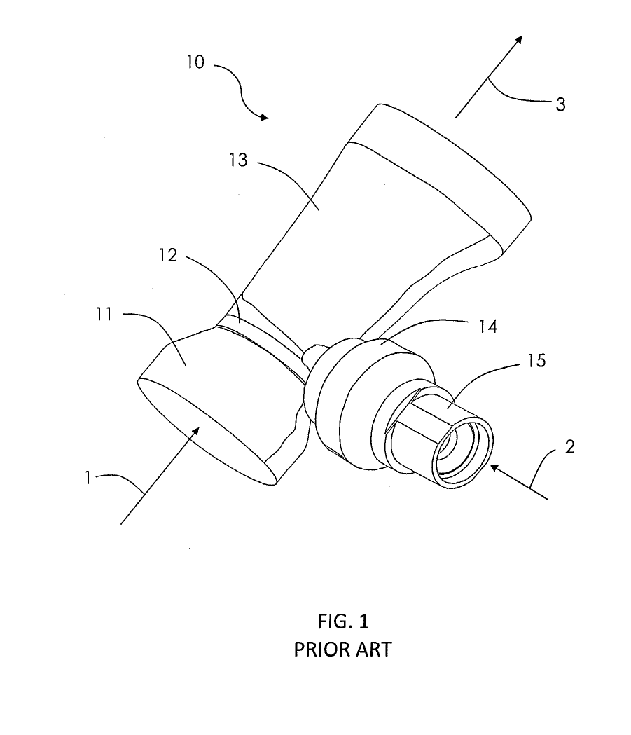

### DETAILED DESCRIPTION OF THE PREFERRED EMBODIMENTS

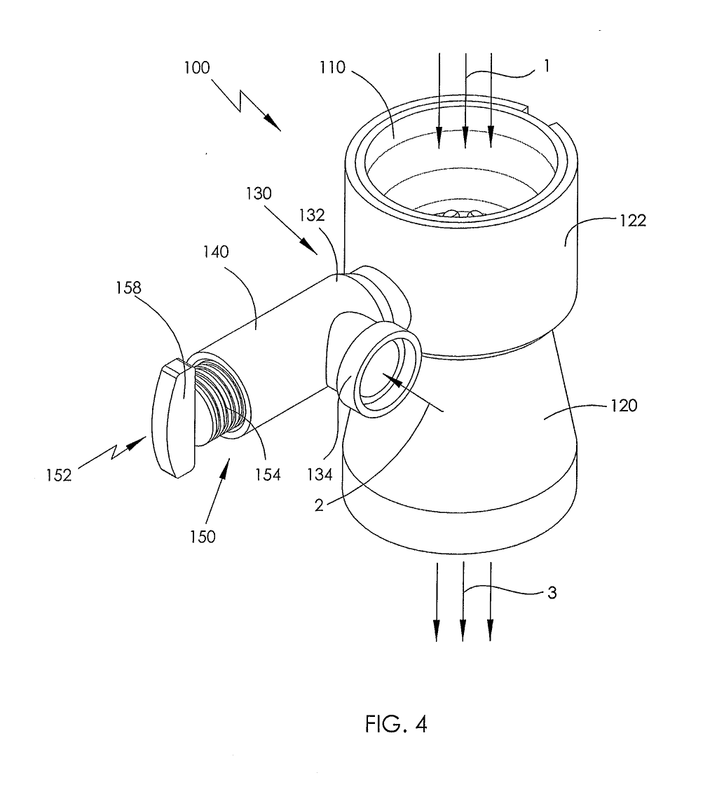

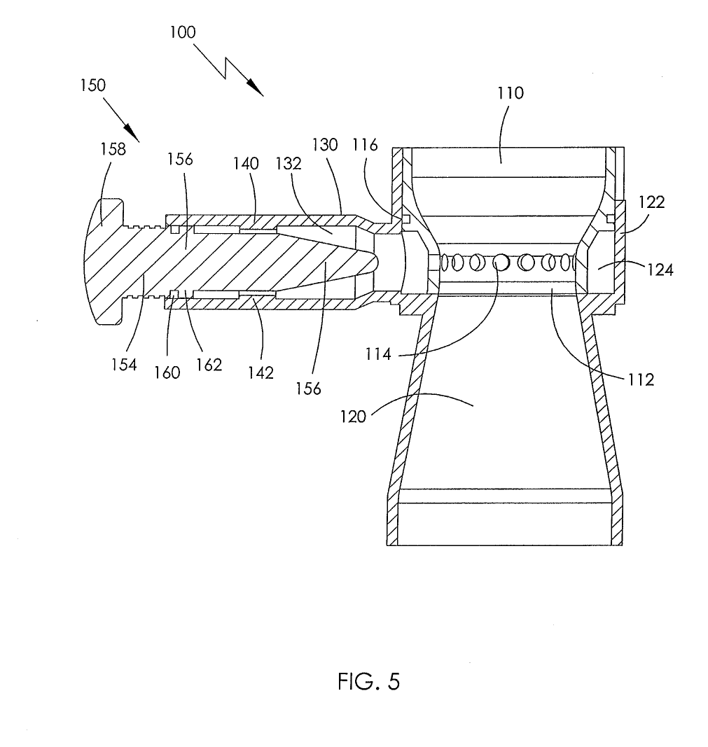

FIGS. 4 and 5 illustrate a venturi mixer 100 in accordance with a preferred embodiment of the present invention. It should be noted that FIGS. 4 and 5 show only those elements of the venturi mixer necessary for the description of the structure. By way of example, a blower (not shown) may be connected to an output of the mixer and a negative pressure regulating valve (not shown) may be connected to a gas inlet of the mixer.

Venturi mixer 100 comprises a first input section 110 defining a first fluid inlet, a second input section 130 defining a second fluid inlet and an output section 120 defining an outlet. As this mixer is designed for mixing air with natural gas, the first input section will be referred to as the air input section 110 and the second input section will be referred to as the gas input section 130. Gas input section 130 includes a flow adjustment mechanism 150 and a gas inlet chamber 132. The gas inlet chamber has a gas inlet 134 and is integrally formed with an annular housing 122. Flow adjustment mechanism 150 comprises a hand screw 152 which screws into a threaded end of a pipe 140 leading to gas inlet chamber 132. Hand screw 152 has a threaded middle section 154 which engages with the internal thread of the pipe, a conical plug 156 at one end of the middle section and a handle or knob 158 at the other for manual manipulation of the hand screw. The middle section has an annular groove 160 for an O-ring seal (not shown) to make the hand screw gas tight with pipe 140. A stop 136 formed inside pipe 134 cooperates with a step 162 on the hand screw to limit the inward movement of the hand screw to set the minimum gas flow. Operation of the hand screw will be described later.

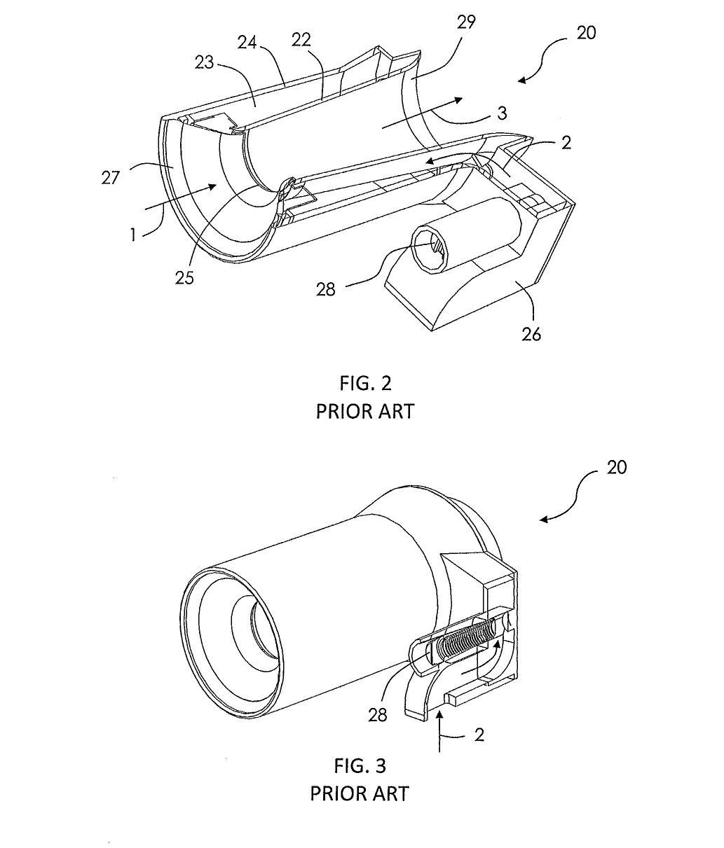

Air input section 110 has a decreasing cross sectional area in the airflow direction and a throat 112 at the narrower end. Air 1 flows into air input section 110. The air experiences a drop in pressure as it passes through throat 112. Multiple orifices 114 (or openings) are formed around throat 112. Housing 122 surrounds throat 112, forming an annular space 124 around throat 112. An annular groove 116 is formed in an outer surface of air input section 110 to accommodate an O-ring seal (not shown) to seal housing 122 to air input section 110 in a gas tight manner. Alternatively, housing 122 and air input section 110 may be hermetically sealed. Gas 2 controlled by flow adjustment mechanism 150 flows from gas input chamber 132 through annular space 124 and orifices 114 into throat 112. Multiple orifices 114 form many injection jets of gas 2 that penetrate into the mainstream of air 1. In this embodiment, gas 2 flows into throat 112 less circuitously, with less resistance, and joins air 1 almost perpendicularly with respect to the direction of flow of air 1. This creates turbulence with deeper penetration of the air flow by the gas. Thus air-gas mixing efficiency is higher than in prior art where injection of gas is provided by a circular gap formed in throat 25, as shown in FIG. 2. This advantage is more pronounced at high flow rates of air 1.

Output section 120 has an increasing cross sectional area in the airflow direction and is connected with the throat 112. Thus air 1 and gas 2 flows into the output section from throat 112 where it experiences a lowering of pressure to further mix the air and gas and the mixed fluid flows out of output section part 120.

Flow adjusting mechanism 150 is used to adjust the flow of gas into the air flow. Hand screw 152 is screwed into or out of pipe 134 to change the position of conical plug 156. With hand screw 152 screwed into pipe 134 so that the seat and the step are in contact, the gas flow is set to the minimum position with the conical plug 156 blocking or substantially obstructing the flow of gas from the gas inlet chamber 132 into annular space 124. As the hand screw is backed out of pipe 134, conical plug 156 opens up the passage between gas inlet chamber 132 and annular space 124 allowing more gas to flow into throat 112 through orifices 114 and mix with the air. As conical plug 156 is conical and is moved into and out of the passage between gas inlet chamber 132 and annular space 124 by a screw thread mechanism, the flow of gas can be easily and precisely adjusted and controlled. Thus, air/gas volume ratio can be controlled more accurately.

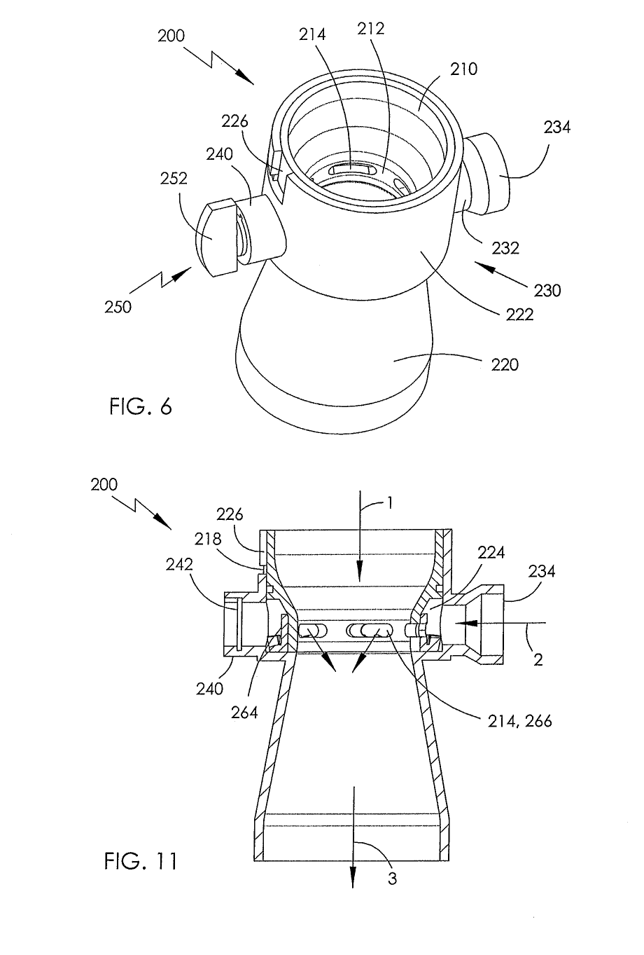

FIG. 6 illustrates a venturi mixer 200 in accordance with another exemplary embodiment of the present invention. Venturi mixer 200 comprises an air input section 210, a gas input section 230, and an output section part 220. Gas input section 230 includes a housing 222, a flow adjustment mechanism 250, and a gas input chamber 232. Gas input chamber 232 includes a gas inlet 234. Flow adjustment mechanism 250 comprises a hand screw 252 inserted into a pipe 240 formed integrally with housing 222. A throat 212 is disposed at the end of air input section 210 and has multiple orifices 214.

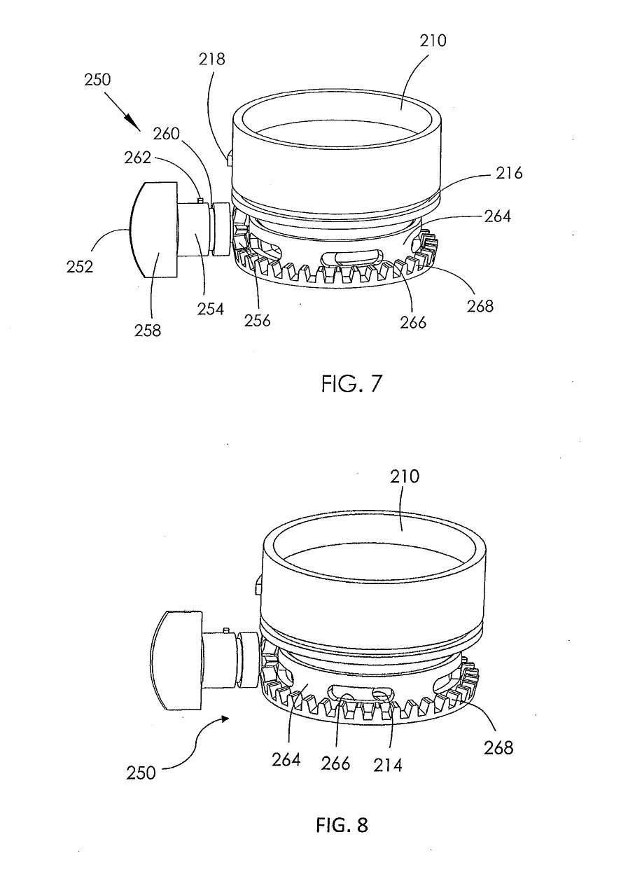

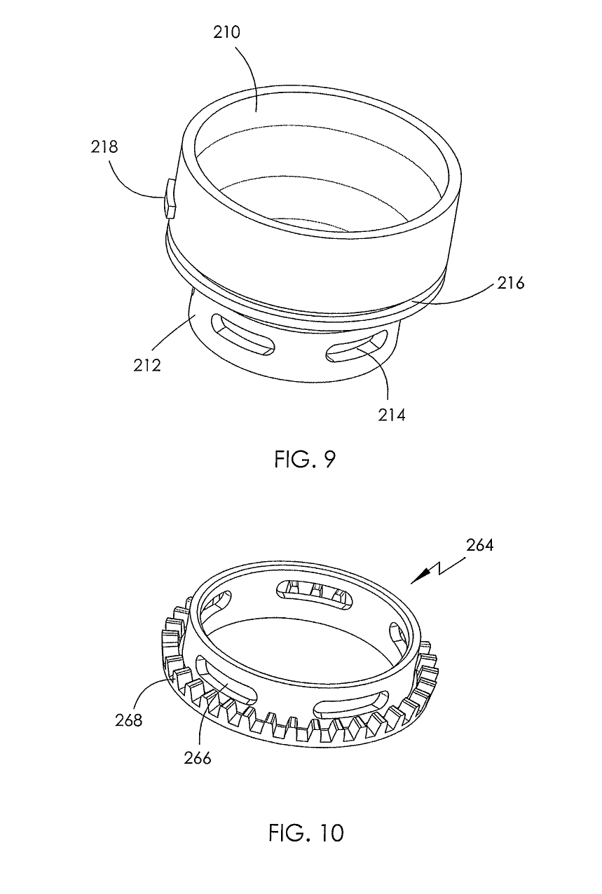

FIG. 7 illustrates flow adjustment mechanism 250 of venture mixer 200, shown mated with air inlet section 210. Flow adjustment mechanism 250 includes a rotatable cover 264 disposed around the outside of throat 212 (shown in FIG. 9), a ring gear 268, and a driving gear 256. Rotatable cover 264 has multiple orifices 266 evenly spaced around it and arranged to be alignable with orifices 214 of throat 212. Driving gear 256 meshes with the teeth of ring gear 268. Hand screw 252 comprises a shaft 254. Driving gear 256 is formed on one end of shaft 254 and a knob or handle 258 is formed on the other end to facilitate manual rotation of the hand screw.

Preferably orifices 266 and orifices 214 have the same the shape, thus the orifices can be aligned to fully overlap. The orifices are shown in FIG. 7 nearly fully aligned. By rotating rotatable cover 264 the size of the passageway formed by the aligned orifices is changed, thus allowing more or less gas to pass through the orifices and mix with the air. FIG. 8 is a view similar to FIG. 7 but with rotatable cover 264 rotated slightly to a position in which the orifices are only slightly aligned, forming a narrow passage restricting the gas from freely flowing into the throat and mixing with the air. Thus by rotating rotatable cover 266 the orifices may be fully opened, fully closed or any desired position there between. Multiple orifices 253 form many gas injection jets that penetrate deeply into the mainstream of airflow in throat 212. In this embodiment, gas 2 flows into throat 212 more directly, i.e., with less fluid resistance compared with prior art, and mixes with air 1 in a direction generally perpendicular manner with respect to the direction of air 1. Thus, air-gas mixing efficiency is higher than in the prior art mixer of FIG. 2. This advantage is more pronounced at high flow rates of mainstream air.

FIG. 9 illustrates air input section 210 of venturi mixer 200 in which air input section 210 has a decreasing cross sectional area and throat 212 has orifices 214 formed evenly spaced around it. An annular groove 216 is formed in the radially outer surface of the air input section for accommodating an O-ring seal (not shown) for sealing the air input section to housing 222. Also visible is a projection 218 formed on the outer surface for interlocking the air input section to the housing.

FIG. 10 illustrates rotatable cover 264. Rotatable cover 264 and ring gear 268 are integrally formed as a monolithic structure, so that rotatable cover 264 rotates with ring gear 268.

As shown in FIG. 11, shaft 254 of hand screw 252 is disposed in pipe 240 in a gas tight manner, so that the ring gear 268 can be driven by driving gear 254. A user may rotate the hand screw by gripping and turning knob 258 to adjust the alignment of orifices 266 of rotatable cover 266 with orifices 214 of throat 212. An O-ring (not shown) disposed in groove 260 seals shaft 254 to pipe 240 while allowing the shaft to turn. A pin 262 formed on shaft 254 cooperates with groove 242 to limit rotation of the hand screw and/or to restrict withdrawal of the hand screw from the pipe. Air input section 210 is preferably fixed to housing 222 by a modified bayonet connection in which slot 226 in housing is L-shaped and projection 218 is located in slot 226 as the two parts are brought together axially and then rotated with respect to each other such that projection 218 is displaced circumferentially into the circumferential portion of slot 226 to prevent axial separation of the two parts. While the parts are shown locked together and sealed by an O-ring seal, the parts may be hermetically sealed by, for example, welding the parts together.

As shown in FIG. 11 output section 220, housing 222, pipe 240 and gas inlet chamber 232 are integrally formed to lower the cost and simplifying the assembly process. Air 1 flows into air input section 210 and out from the output section, experiencing a drop in pressure as it passes throat 212. Gas 2 flows from gas inlet chamber 232, into an annular space 224 around throat 212, then through orifices 266 and orifices 214 into throat 212, and mixes with the air as it passes through output section 220. Annular space 224 is formed between housing 222 and air input section 210 and surrounds the throat. Rotatable cover 264 is disposed within annular space 224.

In accordance with a preferred embodiment of the present invention, air input section 210, gas input section 230, and output section 220 are made of a static dissipative plastics material, which make the whole venturi mixer lighter and easy to manufacture. The static dissipative plastics material may be selected from, but not limited to, a static dissipative acetal resin, a static dissipative polyetherimide thermoplastic or a static dissipative reinforced PTFE (PolyTetraFluoroEthylene).

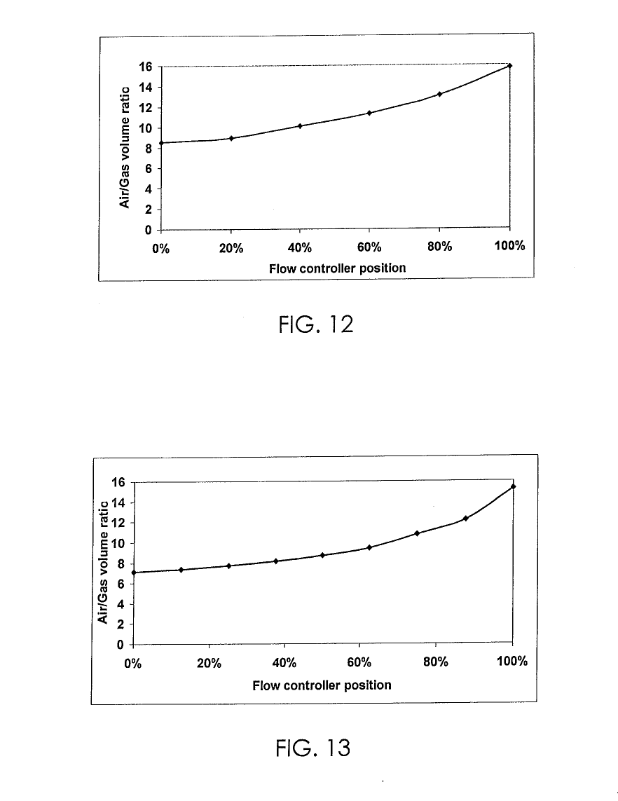

FIGS. 12 to 17 are graphs of results of simulation experiments on prior art venturi mixer shown in FIG. 2, venturi mixer 100 shown in FIG. 4 and venturi mixer 200 shown in FIG. 6. FIG. 12 is a graph illustrating the relationship between air-gas volume ratio and flow controller position, for the venturi mixer of FIG. 2, wherein flow controller position represents the position of screw 28 in adjusting component 26. Zero percent (0%) stands for minimum gas flow position and one hundred percent (100%) stands for maximum gas flow position.

FIG. 13 is a graph illustrating the relationship between air-gas volume ratio and flow controller position for venturi mixer 100 of FIG. 4. Flow controller position represents the position of hand screw 152. Zero percent (0%) stands for minimum gas flow position and one hundred percent (100%) stands for maximum gas flow position. In fact, due to the shape of conical plug 156, flow controller position of venturi mixer 100 the actual length of useful movement of the hand screw may be longer than that of the prior art mixer of FIG. 2, i.e., the path length of conical plug 156 is longer than the path length of screw 28 between same extent of flow controller position (e.g. from 30% to 60%), which can make control of air/gas volume ratio more accurate in a wider range than mixer 20. Venturi mixer 100 can reach an air/gas volume ratio below 8:1, which shows another advantage of this embodiment over the prior art.

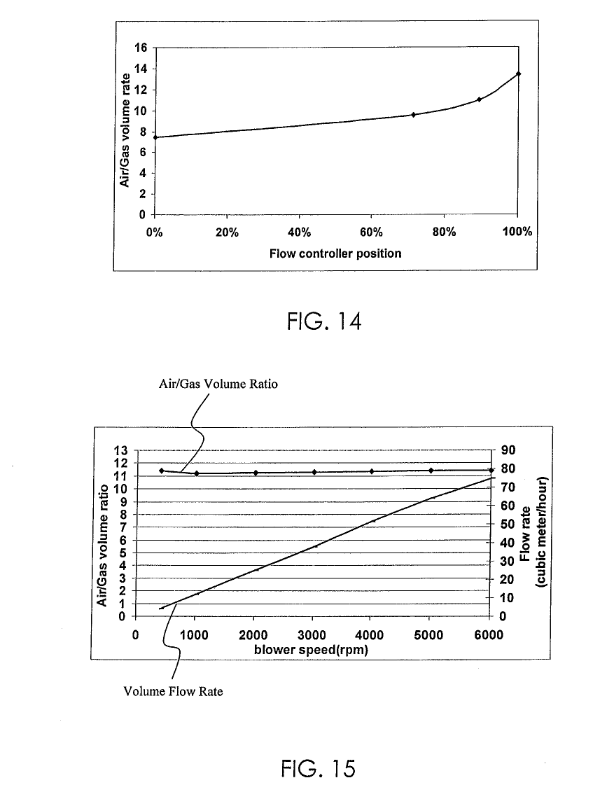

FIG. 14 is a curve illustrating the relationship between air-gas volume ratio and flow controller position for venturi mixer 200 of FIG. 6, wherein flow controller position represents rotatable cover rotation angle degree. Zero percent (0%) stands for minimum gas flow position and 100% stands for maximum gas flow position. Comparing the graphs of FIGS. 12 and 14 we can draw a conclusion that the venturi mixer 200 of FIG. 6 can provide a linear change in air/gas volume ratio over part of the graph, which help a user to control the air-gas volume ratio more conveniently. Also the air/gas volume ratio can be more accurately controlled over a wider range than prior art mixers.

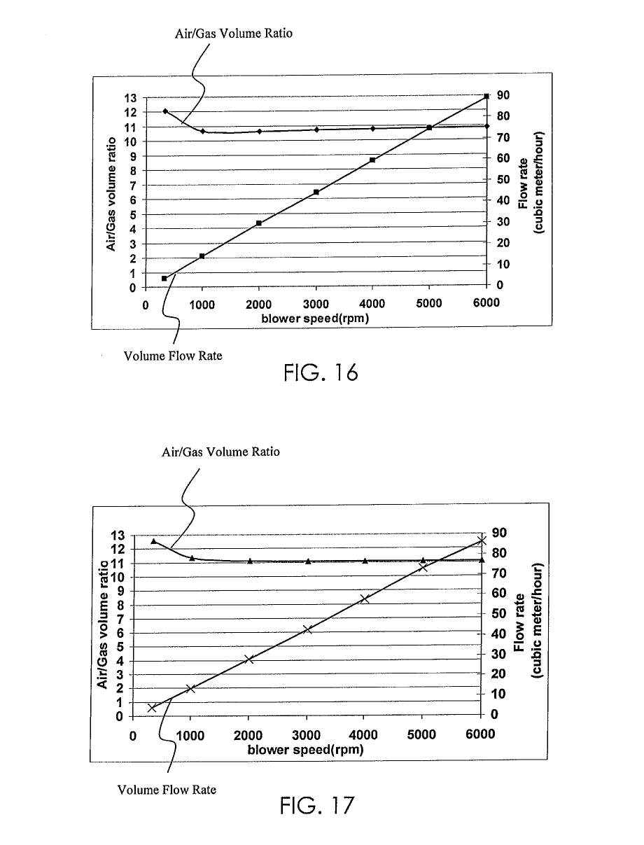

FIG. 15 is a graph illustrating the relationship between air/gas volume ratio, flow rate and blower speed according to the prior art venturi mixer of FIG. 2. FIGS. 16 and 17 are graphs illustrating the relationship between air/gas volume ratio, flow rate and blower speed for venturi mixer 100 of FIG. 4 and venturi mixer 200 of FIG. 6 respectively.

From the relationship between air/gas volume flow ratio and flow rate, as function of blower speed, one can draw a conclusion that the venturi mixers according to the present invention can provide a reliable gas/air volume ratio control at higher flow rates than prior art venturi mixers. This can be advantage, for example, when the premix blower supplies air-gas mixture at a maximum firing rate of the boiler. An additional advantage is that venturi mixers according to the present invention can provide a lean combustion process resulting in minimal CO, NO presence in combustion products.

It should be appreciated that a venturi mixer according to the present invention, can provide an accurate control of gas/air volume ratio over a wide range of air/gas volume ratios and a higher reliability of air gas mixing under a higher blower RPM and maximal mainstream air flow rate. For the same energy input, i.e., at same blower speed, the venturi mixer of the present invention can reach a higher air-gas volume flow rate. The venturi mixer may have a light weight as it can be easy manufactured from static dissipative plastic which limits the build-up of static charges.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A venturi mixer, comprising:
a first fluid input section having a first end and a second end, and an decreasing cross sectional area from the first end to the second end;
a throat disposed at the second end of the first fluid input section and having a first plurality of orifices;
a second fluid input section having an inlet and a housing connected to the inlet and enclosing the plurality of orifices in the throat; and
an output section having a first end connected with the throat and a second end, and an increasing cross sectional area from the first end to the second end.

2. The venturi mixer of claim 1, wherein the second fluid input section further comprises a flow adjustment mechanism connected to the housing.

3. The venturi mixer of claim 2, wherein the second fluid input section includes an inlet chamber and the flow adjustment mechanism includes a movable conical plug disposed in the inlet chamber.

4. The venturi mixer of claim 3, wherein the flow adjustment mechanism comprises a hand screw threadedly engaged with a pipe extending from the inlet chamber and wherein the conical plug is located on an inner axial end of the hand screw.

5. The venturi mixer of claim 3, wherein the conical plug is arranged to provide an adjustable restriction to the flow of fluid from the inlet chamber to the orifices in the throat.

6. The venturi mixer of claim 2, wherein the flow adjustment mechanism comprises a cover rotatably disposed about a radially outer surface of the throat;
the cover having a second plurality of orifices that are alignable with the first plurality of orifices in the throat; and
the cover being movable to selectively align or misalign the orifices in the cover with the orifices in the throat to vary the flow of fluid through the orifices in the throat.

7. The venturi mixer of claim 6, wherein the cover is rotatable between a first position in which the orifices in the throat are fully open and a second position in which the orifices in the throat are fully closed.

8. The venturi mixer of claim 6, wherein the flow adjustment mechanism includes:
a ring gear fixed to the cover; and
a driving gear, in mesh with the ring gear, for rotating the cover.

9. The venturi mixer of claim 8, wherein the flow adjustment mechanism further comprises a hand screw having a shaft rotatably sealed to and extending through the housing, an axially inner end of the shaft is joined to the driving gear and the other end of the shaft forms a handle.

10. The venturi mixer of claim 9, wherein the driving gear and the shaft are integrally formed as a monolithic structure.

11. The venturi mixer of claim 8, wherein the gear ring and the rotatable cover are integrally formed as a monolithic structure.

12. The venturi mixer of claim 1, wherein the output section and the housing are integrally formed as a monolithic structure.

13. The venturi mixer of claim 1, wherein the first fluid input section, the second fluid input section, and the output section are made of static dissipative plastic.
